(19) United States
(12) Patent Application Publication
(10) Pub. No.: US 2011/0096169 A1
(43) Pub. Date: Apr. 28, 2011

(54) CAMERA TRACKING SYSTEM AND METHOD, AND LIVE VIDEO COMPOSITING SYSTEM

(75) Inventors: Jung Jae YU, Gyeonggi-do (KR); Jae Hean Kim, Gyeonggi-do (KR); Hye Mi Kim, Daejeon (KR); Jin Ho Kim, Daejeon (KR); Il Kwon Jeong, Daejeon (KR)

(73) Assignee: Electronics and Telecommunications Research Institute, Daejeon (KR)

(21) Appl. No.: 12/909,139

(22) Filed: Oct. 21, 2010

(30) Foreign Application Priority Data
Oct. 22, 2009 (KR) 10-2009-0100738

(51) Int. Cl. H04N 7/18

(52) U.S. Cl. 348/159; 348/E07.086

(57) ABSTRACT

Provided are a camera tracking system and method and a live video compositing system using the same, which track a main camera with a sub-camera attached to the main camera and thus stably calculate the motion of the main camera even in a dynamic case where most of a static background is occluded by a moving foreground object. The camera tracking system and the live video compositing system can connect feature point tracks that are cut by a foreground object which dynamically moves in an image. Accordingly, the camera tracking system and the live video compositing system can perform the more accurate and quick tracking of a camera even in a case where a foreground object occludes background by dynamically moving.

### CROSS-REFERENCE TO RELATED APPLICATIONS

This application claims priority under 35 U.S.C. §119 to Korean Patent Application No. 10-2009-0100738, filed on Oct. 22, 2009, in the Korean Intellectual Property Office, the disclosure of which is incorporated herein by reference in its entirety.

### TECHNICAL FIELD

The following disclosure relates to a camera tracking system and method and a live video compositing system using the same, and in particular, to a camera tracking system and method and a live video compositing system using the same, which track a main camera with a sub-camera attached to the main camera and thus stably calculate the motion of the main camera even in a dynamic case where most of a static background is occluded by a moving foreground object.

### BACKGROUND

In creating movie or the content of advertisement broadcasting, a virtual camera is moved in a CG space according to the motion of a camera that photographs a live video and thereby a CG object is rendered, for inserting the CG object into the live video. In this case, awkwardness due to compositeness may be eliminated only when the motion of a virtual camera is accurately matched with the motion of a real camera.

In the post production of movie, camera tracking uses match-moving software such as Boujou. However, such a way is unsuitable because it is difficult to trace a long feature point in a dynamic image where a foreground object (for example, live actor) occludes most of a screen or violently moves. These limitations may not be overcome in an image-based camera tracking part that receives only a live video to be used in the final composite image.

In a real movie CG production, accordingly, when tracing all feature points is broken due to the violent motion of a foreground object, CG artists should manually estimate key frame motion.

### SUMMARY

In one general aspect, a camera tracking system includes: a main camera photographing a main image to be used in compositeness; a sub-camera attached to the main camera to photograph a sub-image; a tracking unit tracing a feature point track of the sub-image to estimate a motion of the sub-camera; a motion conversion unit converting the motion of the sub-camera into a motion of the main camera on the basis of a position relationship between the main camera and the sub-camera; a reconstruction unit tracing the feature point track of the main image to restore the traced feature point track of the main image to a Three-Dimensional (3D) space; and an optimization unit adjusting the restored 3D coordinates of the feature point track of the main image, 3D coordinates of the feature point track of the sub-image, a motion variable of the main camera and a motion variable of the sub-camera to optimize the converted motion of the main camera.

In another general aspect, a camera tracking method includes: estimating a position relationship between a main camera and a sub-camera attached to the main camera; obtaining a main image to be used in compositeness from the main camera, and obtaining a sub-image from the sub-camera; estimating a motion of the sub-camera with a feature point track of the sub-image; converting the motion of the sub-camera into a motion of the main camera on the basis of the position relationship between the main camera and the sub-camera; tracing the feature point track of the main image to restore the traced feature point track of the main image to a Three-Dimensional (3D) space; and optimizing the converted motion of the main camera by adjusting 3D coordinates of the feature point track of the main image, 3D coordinates of the feature point track of the sub-image and a variable of the sub-camera.

In another general aspect, a live video compositing system includes: a main camera photographing a main image to be used in compositeness; a sub-camera attached to the main camera to photograph a sub-image; a tracking unit tracing a feature point track of the sub-image to estimate a motion of the sub-camera; a motion conversion unit converting the motion of the sub-camera into a motion of the main camera on the basis of a position relationship between the main camera and the sub-camera; a reconstruction unit tracing the feature point track of the main image to restore the traced feature point track of the main image to a Three-Dimensional (3D) space, and connecting a plurality of cut feature point tracks by using the converted motion of the main camera and a feature point track which is restored to the 3D space; an optimization unit adjusting the restored 3D coordinates of the feature point track of the main image, 3D coordinates of the feature point track of the sub-image, a motion variable of the main camera and a motion variable of the sub-camera to optimize the converted motion of the main camera; a CG object unit generating a CG object to be used in compositeness; and a compositing unit compositing the main image and the CG object by using the optimized motion of the main camera.

Other features and aspects will be apparent from the following detailed description, the drawings, and the claims.

### BRIEF DESCRIPTION OF THE DRAWINGS

FIG. 1 is a block diagram schematically illustrating a camera tracking system according to an exemplary embodiment.

FIG. 2 is a diagram illustrating a case in which a foreground object moves dynamically.

FIG. 3 is a diagram illustrating an example of the fixed state of a main camera and a sub-camera.

FIG. 4 is a diagram illustrating an example of a main image which is photographed by the main camera.

FIG. 5 is a diagram illustrating an example of a sub-image which is photographed by the sub-camera.

FIG. 6 is a diagram illustrating an error in a case which converts the motion of the sub-camera into the motion of the main camera through a motion conversion unit in FIG. 1.

FIG. 7 is a block diagram illustrating a live video compositing system using a camera tracking system according to an exemplary embodiment.

FIG. 8 is a diagram illustrating the result of a rotoscoping production in which a compositing unit in FIG. 7 extracts a foreground object region from a main image.

FIG. 9 is a diagram illustrating a result in which a CG object is inserted into FIG. 8.

FIG. 10 is a flow chart illustrating a camera tracking method according to an exemplary embodiment.

FIG. 11 is a diagram illustrating an operation which calculates the spatial position relationship between a main camera and a sub-camera in FIG. 10.

FIG. 12 is a diagram illustrating an operation which restores the feature point track of a main image to three-dimensional coordinates.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Hereinafter, a camera tracking system according to exemplary embodiments will be described with reference to the accompanying drawings.

FIG. 1 illustrates a camera tracking system according to an exemplary embodiment.

Referring to FIG. 1, a camera tracking system according to an exemplary embodiment includes a main camera 110, a sub-camera 120, a time synchronization unit 130, an calibration unit 140, a tracking unit 150, a motion conversion unit 160, a reconstruction unit 170, and an optimization unit 180. In specification, a static image denotes one in which background is not occluded by a foreground object, and a dynamic image denotes one in which background may be occluded by a foreground object.

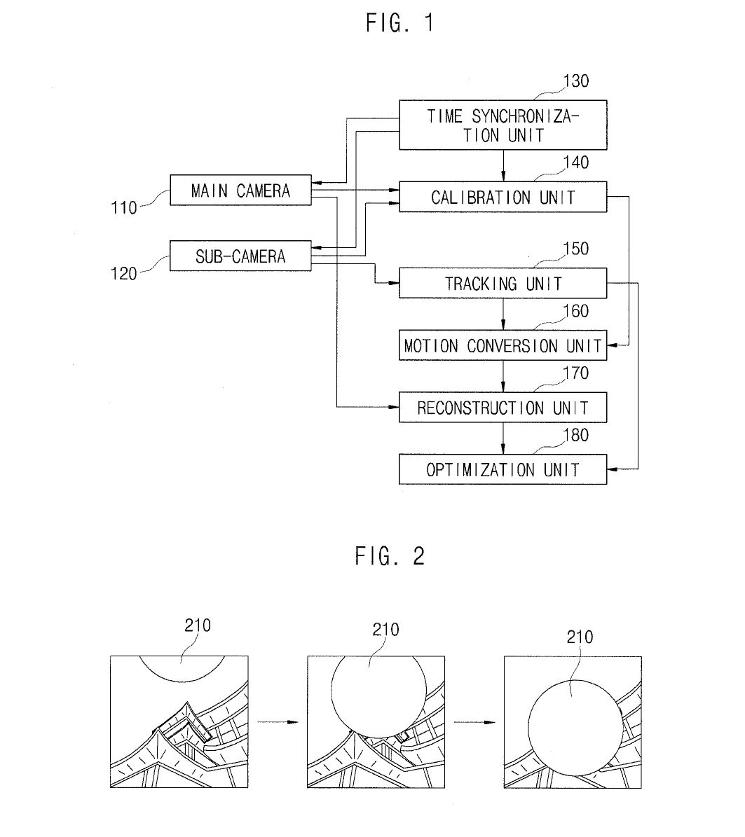

The main camera 110 photographs a main image, being a live video, to be used in the compositing of computer graphics. The main image, as illustrated in FIG. 2, includes a static image and a dynamic image in which background is occluded by the dynamic motion of a foreground object. FIG. 2 illustrates an image in which a ball 210 being a foreground object occludes a building being background while falling.

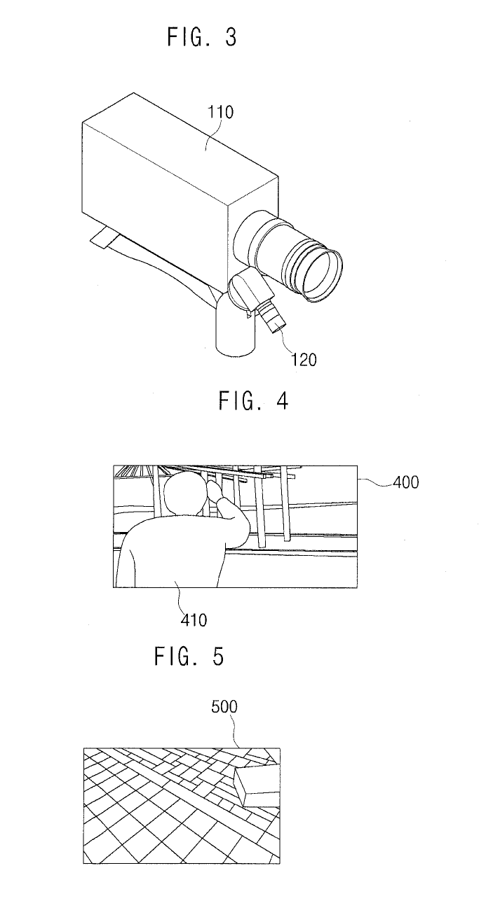

The sub-camera 120 is fixed in a certain position of the main camera 110. The sub-camera 120, as illustrated in FIG. 3, may be fixed downward. The sub-camera 120 photographs a sub-image for camera tracking while the main camera 110 is photographing the main image to be used in compositeness. For example, while the main camera 110 is photographing an image 400 in which a foreground object 410 looks at a specific place as shown in FIG. 4, the sub-camera 120 may photograph a static image 500 (for example, the bottom of a building).

The time synchronization unit 130 controls time synchronization between the main camera 110 and the sub-camera 120. Time synchronization may include the synchronization of mechanical operations and time code matching between the sequence of a main image and the sequence of a sub-image. For example, the synchronization of a mechanical operation may undergo generator lock (genlock) that synchronizes the timing of the sub-camera 120 with the phase of the main camera 110.

The calibration unit estimates the spatial position relationship between the main camera 110 and the sub-camera 120, and measures the internal variable of the main camera 110 and the internal variable of the sub-camera 120 before photograph. The internal variable denotes the state information of a camera that includes the focal length, skew and axis of the camera.

For example, the internal variable of a camera may be based on the Zhang's camera calibration method using a plurality of rectangular pattern images. The spatial position relationship between the main camera 110 and the sub-camera 120 may be based on a method using the Kumar's mirror. The spatial position relationship that is calculated by the calibration unit 140 is inputted to the motion conversion unit 160, and the internal variable of a camera is inputted to the optimization unit 180.

The tracking unit 150 may trace the track of a feature point in each frame of a sub-image and estimate the motion of the sub-camera 120 on the basis of traced data. For example, the track tracing of a feature point may be based on Kanade Lucas Tomasi (KLT) feature tracker, and the motion of the sub-camera 120 may be based on a Structure from Motion (SfM) technique.

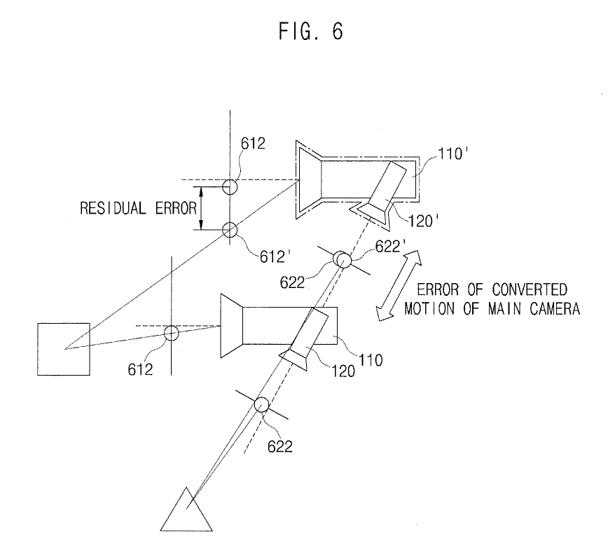

The motion conversion unit 160 converts the motion of the sub-camera 120 that is estimated in the tracking unit 150 into the motion of the main camera 110. The converted motion of the main camera 110 is primary information, and a Reprojection Error (RPE) is generated. Accordingly, the converted motion itself of the main camera 110 cannot directly be used in the compositing of computer graphics. The reprojection error of the converted motion of the main camera 110 is relatively greater than that of the sub-camera 120. The reprojection error denotes an error between a feature point when again projecting a feature point restored to a Three Dimension (3D) phase onto the image plane of a camera and a feature point that is traced through KLT feature point tracing. This will be described below in more detail with reference to FIG. 6.

As illustrated in FIG. 6, there are few errors between the coordinates 622′ of a feature point when again projecting the feature point of a 3D-restored sub-image onto the image plane of the sub-camera 120 and the coordinates 622 of a feature point that is traced through KLT feature point tracing. However, when predicting the motion of the main camera 110 on the basis of the motion of the sub-camera 120 having the few errors, errors occur between the feature point 612 of a real main image and the feature point 612′ of the converted main image by a residual error. When using the motion of the main camera 110 having a high reprojection error as-is, shake occurs between a computer graphic object and live background in the compositing of computer graphics. Accordingly, the quality of a composited material is degraded. Therefore, a reconstruction unit and an optimization unit are required for minimizing a reprojection error. In FIG. 6, reference numeral 612 indicates the motion of the real main camera 110, reference numeral 622 indicates the motion of the real sub-camera 120, reference numeral 612′ indicates the motion of the main camera 110 that is predicted by the motion conversion unit 160, and reference numeral 622′ indicates the motion of the sub-camera 120 that is estimated in the tracking unit 150. In FIG. 6, tetragon and triangle indicate image planes.

The reconstruction unit 170 traces the feature point track of a main image and restores the traced feature point track to a 3D space. The main image includes a dynamic image in which a foreground object dynamically moves. In most of the dynamic image, the feature point track may not be long connected and may be shortly cut. The reconstruction unit 170 may connect the shortly-cut feature point track by using the motion of the main camera 110 inputted from the motion conversion unit 160 and the feature point track restored to the 3D space. An operation in which the reconstruction unit 170 restores the feature point track to the 3D space and an operation in which the reconstruction unit 170 connects the cut feature point track will be described below in a corresponding portion.

The optimization unit 180 receives the feature point track of the main image from the reconstruction unit 170, and receives the motion variable of the sub-camera 120 and the feature point track of the sub-image from the tracking unit 150. Because the motion variable of the main camera 110 may be calculated with the motion variable of the sub-camera 120, a motion variable may not separately be inputted. As the motion variable, for example, there are the rotation matrix and moving vector of a camera.

The optimization unit 180 receives the feature point track of a sub-image, the feature point track of a main image and the motion variable of each camera, and adjusts the 3D coordinates of the feature point track of the sub-image, the 3D coordinates of the feature point track of the main image, the motion variable value of the sub-camera 120 and the motion variable value of the main camera 110 in order to minimize Equation (1). Since the motion variable value of the main camera 110 may be calculated from the motion variable value of the sub-camera 120, the motion variable value of the main camera 110 may be adjusted by adjusting the motion variable value of the sub-camera 120.

Equation (1) expresses the sum of the detection value and prediction value of a feature point track in the image plane of each frame of each main image and sub-image. The detection value denotes the 2D coordinates of a feature point track that is estimated through KLT tracing, and the prediction value denotes the 2D coordinates of a feature point track in an image plane that is obtained by reprojecting the 3D coordinates of a feature point track.

$${\sum }_{j} ( {\sum }_{i = 1}^{{n}_{main}} {‖ {x}_{main , i}^{j} - π ( {X}_{main , i} , {R}_{main}^{j} , {t}_{main}^{j} ) ‖}^{2} + {\sum }_{i = 1}^{{n}_{sub}} {‖ {x}_{sub} , {i}^{j} - π ( {X}_{sub} , i , {R}_{sub}^{j} , {t}_{sub}^{j} ) ‖}^{2} ) \qquad ( 1 )$$

where x^{j}_{main,i} is a detection value and the coordinates of an ith feature point in the jth frame of a main image, X_{main,i} is a prediction value and is the coordinates of the ith feature point on 3D space in main image, R^{j}ₘₐᵢₙ is the rotation matrix of the main camera 110, t^{j}ₘₐᵢₙ is the moving vector of the main camera 110, x^{j}_{sub,i} is a detection value and is the coordinates of an ith feature point in the jth frame of a sub-image, X_{sub,i} is a prediction value and is the coordinates of the ith feature point on 3D space in sub image, R^{j}_{sub} is the rotation matrix of the sub-camera 120, t^{j}_{sub} is the moving vector of the sub-camera 120, “π” is a function that calculates 2D coordinates by projecting a feature point on a 3D space to the image plane with a projection matrix.

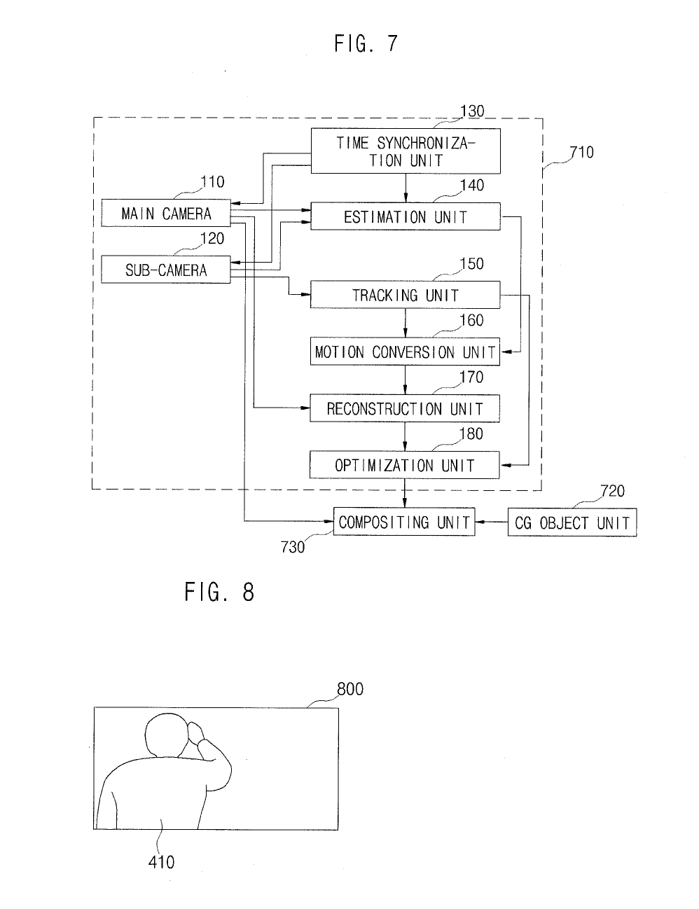

FIG. 7 illustrates a live video compositing system using a camera tracking system 710 according to an exemplary embodiment.

Referring to FIG. 7, a CG object unit 720 models a CG object to be used in the compositeness of computer graphics to generate an animation and a texture.

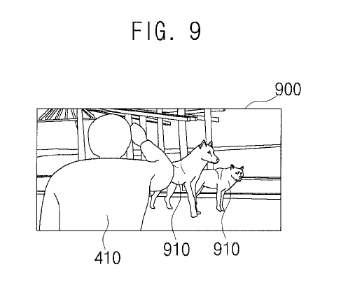

The compositing unit 730 receives the optimized motion of the main camera 110 from the optimization unit 180, and receives a CG object to be used in compositeness from the CG object unit 720. The compositing unit 730 composites the main image of a live video and the CG object on the basis of information of the optimized motion of the main camera 110. The compositing unit 730 may perform a rotoscoping production that extracts a foreground object region from a main image for an inserted CG object not to be overlapped on a foreground object. As an example, FIG. 8 illustrates the result 800 of rotoscoping. FIG. 9 illustrates a result which is obtained through the processing of the compositing unit 730. An image in which wolves 900 run in front of a person 410 being a foreground object may be outputted as a final compositeness result 900.

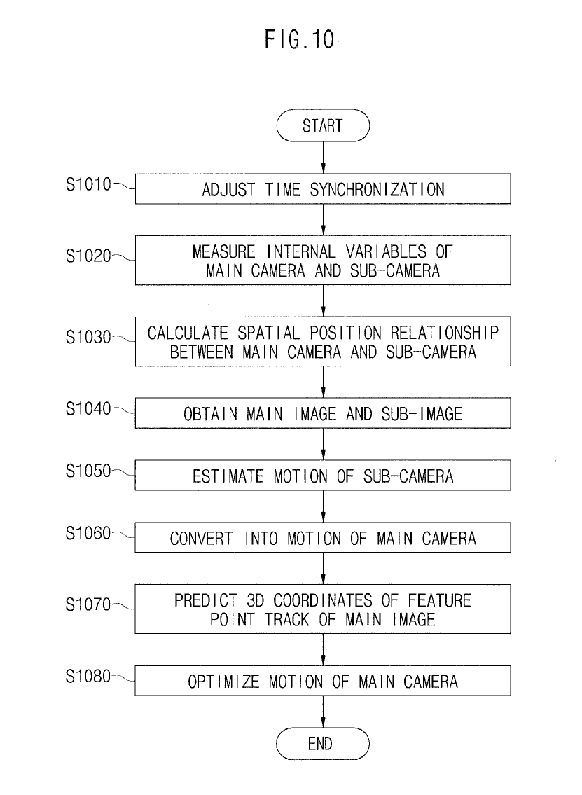

Hereinafter, a camera tracking method will be described with reference to the accompanying drawings. FIG. 10 illustrates a camera tracking method according to an exemplary embodiment.

Referring to FIG. 10, the time synchronization unit 130 controls time synchronization between the main camera 110 and the sub-camera 120 in operation S1010. Time synchronization, for example, includes the synchronization of mechanical operations that is achieved through genlock and time code matching between the sequence of a main image and the sequence of a sub-image.

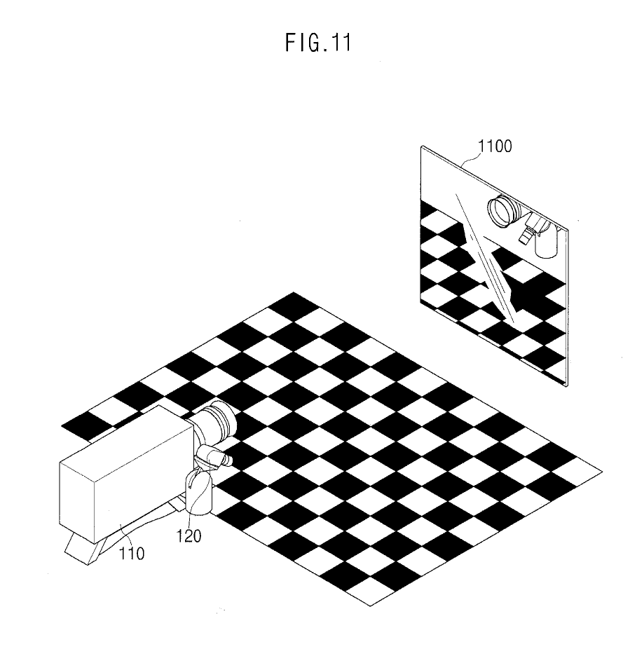

The calibration unit 140 measures the internal variable of the main camera 110 and the internal variable of the sub-camera 120 in operation S1020, and calculates the spatial position relationship between the main camera 110 and the sub-camera 120 in operation S1030. As an example of a method for measuring an internal variable, there is the Zhang's calibration method using a rectangular pattern image. The Zhang's calibration method may enable to manage radial distortion, thereby obtaining a camera internal variable having high accuracy. As an example of a method for estimating spatial position relationship, there is a method using the Kumar's mirror. FIG. 11 illustrates an operation for calculating the spatial position relationship between the main camera 110 and the sub-camera 120 using the Kumar's mirror.

The main camera 110 obtains a main image, being a live video, to be used in compositeness, and the sub-camera 120 attached to the main camera 110 obtains a sub-image for camera tracking in operation S1040. The main image photographed by the main camera 110 includes a static image and a dynamic image in which a foreground object moves dynamically. The sub-camera 120, as described above, photographs a bottom being a static background. The sub-image is inputted to the tracking unit 150.

The tracking unit 150 estimates the motion of the sub-camera 120 by using the feature point track of the sub-image in operation S1050. For example, the tracking unit 150 traces a feature point track in the each frame of the sub-image, and estimates the motion of the sub-camera 120 in an SIM scheme by using the traced feature point track. The motion of the sub-camera 120 can increase accuracy using the internal variable of the sub-camera 120 that has been measured through operation S1020. Tracing the feature point may use KLT feature point tracing.

The motion conversion unit 160 converts the motion of the sub-camera 120 into the motion of the main camera 110 on the basis of the spatial position relationship between the main camera 110 and the sub-camera 120 in operation S1060. In operation S1060, the converted motion of the main camera 110 is primary information, as described above with reference to FIG. 6, and a reprojection error is generated. The reprojection error is minimized through operations 51070 and S1080, and thus the optimized motion of the main camera 110 can be outputted.

The reconstruction unit 170 predicts the 3D coordinates of the feature point track of the main image and connects a feature point tracks that is cut in operation S1070. For example, the reconstruction unit 170 traces the feature point track of the main image and restores the traced feature point track to 3D coordinates in operation S1072. Subsequently, the reconstruction unit 170 connects cut tracks among feature point tracks in operation S 1074. The feature point track of the main image may also be traced through KLT feature point tracing.

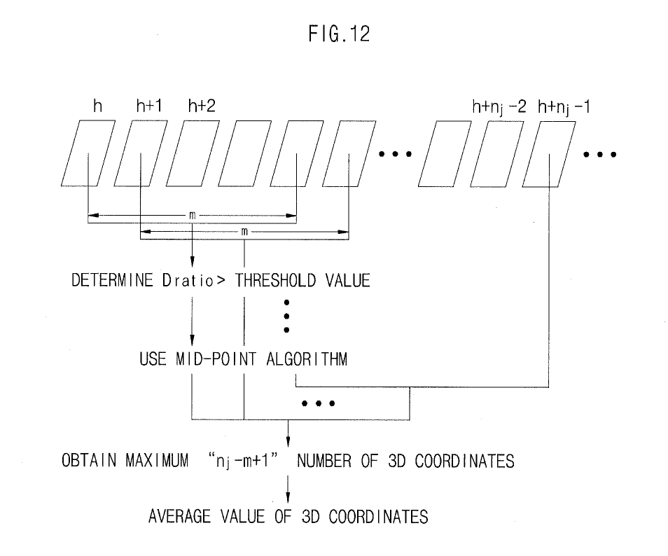

Operation S 1072 will be described below in detail with reference to FIG. 12. A feature point track based on KLT feature point tracing may exist over a plurality of frames. In FIG. 12, ‘h’ is a frame number from which a feature point track is started, and ‘nⱼ’ is a frame length in which the feature point track is continued.

First, among an nⱼ number of frames, two frames that are separated at intervals of m frames are connected as one pair. Frame intervals of m (where 1≦m≦nⱼ) for connection may be adjusted by a user. When distance Dᵣₐₜᵢₒ between the centers of cameras in two frames composing a pair of frame is greater than a threshold value, a corresponding frame is one that secures a sufficient base line. Accordingly, the reconstruction unit 170 may select a frame pair, in which distance between the centers of cameras is greater than the threshold value, as an effective frame pair. By processing the effective frame pair according to a mid-point algorithm, coordinates on 3D space are obtained.

To repetitively perform such an operation, a maximum “nⱼ−m+1” number of 3D coordinates are obtained. The average value of the obtained 3D coordinates is a value in which a corresponding feature point track is restored to 3D coordinates.

Subsequently, an example of operation S1074 will be described as follows. The reconstruction unit 170 connects a cut feature point track by using the 3D-restored coordinates of the feature point track of the main image and the motion of the main camera 110 which is the result material of the tracking unit 150.

First, similarity Sᵢⱼₖ between the ith feature point track (3D coordinates: Xᵢ) and jth feature point track “xⱼ” of the main image is expressed as Equation (2).

$${S}_{ijk} = \frac{Cross - Correlation ( {p}_{i} , {p}_{jk} )}{‖ \overline{{x}_{ik}} - {x}_{jk} ‖} \qquad ( 2 )$$

where x̅ᵢ̅ₖ̅ is a result of the multiplication of Xᵢ and a projection matrix “Pₖ” and is a prediction value for the frame “k” of an ith feature point track, wherein the projection matrix “Pₖ” is the projection matrix of the main camera 110 in the frame “k”, and the frame “k” is any one frame in a frame section where a feature point track “xⱼ” is shown. A jth feature point track “xⱼ” is obtained from the motion of the main camera 110 which is the result material of the tracking unit 150. xⱼₖ is the coordinates of the jth feature point track “xⱼ” that is detected in the frame “k” and is a detection value. Cross-Correlation is a value that is obtained through cross-correlation in an image plane. pᵢ is the patch of an ith 3D feature point, and pⱼₖ is the patch of the jth feature point track that is detected in the frame “k”. Although x̅ᵢ̅ₖ̅ and xⱼₖ are the same feature point, since they are cut by a dynamically-moving foreground object and thereby appear, a production is required for connecting the cut feature points.

Subsequently, Equation (3) is executed using the result of Equation (2). Equation (3) expresses the final similarity Sᵢⱼ between an ith 3D feature point and a jth feature point track.

$${S}_{ij} = \frac{{e}_{i}}{{n}_{j}} {\sum }_{k = {q}_{j}}^{{q}_{j} + {n}_{j} - 1} {S}_{ijk} \qquad ( 3 )$$

where eᵢ is the reprojection error of an ith feature point, and nⱼ is the length of a frame in which a jth feature point track is detected.

The following algorithm is one that illustrates the operation for connecting feature point tracks that are cut, i.e., an operation for connecting tracks that are the same feature point and are cut into two or more feature point tracks and are hereby detected.

```
FOR j = 0;Nⱼ
  (Nⱼ IS THE NUMBER OF SHORT FEATURETRACKS)
FOR i = 0;Nⱼ
  (Nⱼ IS THE NUMBER OF RECONSTRUCTED FEATURES)
  Sₛᵤₘ = 0;
FOR k = qⱼ : qⱼ + nⱼ − 1
  (qⱼ IS THE FIRST FRAME OF xⱼ)
  (nⱼ IS THE LEANGTH OF FRAME OF xⱼ)
X̅_{i ,k} = PₖXᵢ ;
Sₛᵤₘ+ = Sᵢⱼₖ( X̅_{i ,k},x_{j,k},pᵢ,p_{j,k}) ;
END
Sᵢⱼ=(eᵢ/nⱼ)Sₛᵤₘ;
END
iₘₐₓ=argmax(Sᵢⱼ) ;
IF Sᵢₘₐₓⱼ>th
THEN REGARD xⱼ TO BELONG TO Xᵢₘₐₓ ;
END
END
```

The 3D coordinates of the feature point track of the main image that are obtained through operation S1072 are connected through operation S1074, and the connected 3D coordinates of the feature point track is inputted to the optimization unit 180.

The optimization unit 180 adjusts the 3D coordinates of the feature point track of the main image, the 3D coordinates of the feature point track of the sub-image, the motion variable of the main camera 110 and the motion variable of the sub-camera 120. The optimization unit 180 obtains the combination of variables for minimizing the result of Equation (1). The combination of variables for minimizing Equation (1) is a value for minimizing the reprojection error of the main camera 110 and the reprojection error of the sub-camera 120. The optimization unit 180 optimizes the motion of the main camera 110 with the value in operation S 1080. The motion variable of the main camera 110 may be calculated from the motion variable of the sub-camera 120, and thus the optimization unit 180 adjusts the 3D coordinates of the feature point track of the main image, the 3D coordinates of the feature point track of the sub-image and the motion variable value of the sub-camera 120, thereby minimizing the motion of the main camera 110.

When camera tracking according to an exemplary embodiment is ended, the compositing unit 730 composites a CG object inputted from the CG object unit 720 and a live video obtained through the main camera 110 in operation S1090. When compositing the CG object and the live video, the compositing unit 730 uses the optimized motion information of the main camera 110 that is inputted from the optimization unit 180. The compositing unit 730 may perform a rotoscoping production that extracts a foreground object region from the main image for the inserted CG object not to be overlapped on a foreground object.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A camera tracking system, comprising:
a main camera photographing a main image to be used in compositeness;
a sub-camera attached to the main camera to photograph a sub-image;
a tracking unit tracing a feature point track of the sub-image to estimate a motion of the sub-camera;
a motion conversion unit converting the motion of the sub-camera into a motion of the main camera on the basis of a position relationship between the main camera and the sub-camera;
a reconstruction unit tracing the feature point track of the main image to restore the traced feature point track of the main image to a Three-Dimensional (3D) space; and
an optimization unit adjusting the restored 3D coordinates of the feature point track of the main image, 3D coordinates of the feature point track of the sub-image, a motion variable of the main camera and a motion variable of the sub-camera to optimize the converted motion of the main camera.

2. The camera tracking system of claim 1, further comprising a time synchronization unit adjusting time synchronization between the main camera and the sub-camera.

3. The camera tracking system of claim 2, wherein the time synchronization comprises synchronization of mechanical operations of the main camera and sub-camera, and time code matching between a sequence of the main image and a sequence of the sub-image.

4. The camera tracking system of claim 1, wherein the sub-image is a static image in which background is not occluded by a foreground object.

5. The camera tracking system of claim 1, further comprising an calibration unit estimating a position relationship between the main camera and the sub-camera.

6. The camera tracking system of claim 1, wherein the reconstruction unit connects a plurality of cut feature point tracks by using the converted motion of the main camera and the feature point track of the main image which is restored to the 3D space.

7. The camera tracking system of claim 6, wherein the reconstruction unit connects the cut tracks by using similarity between a feature point of any one track and a feature point of another track among the cut tracks.

8. The camera tracking system of claim 1, wherein:
the motion variable of the sub-camera comprises a rotation and movement of the sub-camera, and
the motion variable of the main camera comprises a rotation and movement of the main camera.

9. The camera tracking system of claim 1, wherein the motion variable of the main camera is calculated from the motion variable of the sub-camera.

10. A camera tracking method, comprising:
estimating a position relationship between a main camera and a sub-camera attached to the main camera;
obtaining a main image to be used in compositeness from the main camera, and obtaining a sub-image from the sub-camera;
estimating a motion of the sub-camera with a feature point track of the sub-image;
converting the motion of the sub-camera into a motion of the main camera on the basis of the position relationship between the main camera and the sub-camera;
tracing the feature point track of the main image to restore the traced feature point track of the main image to a Three-Dimensional (3D) space; and
optimizing the converted motion of the main camera by adjusting 3D coordinates of the feature point track of the main image, 3D coordinates of the feature point track of the sub-image and a variable of the sub-camera.

11. The camera tracking method of claim 10, further comprising adjusting time synchronization between the main camera and the sub-camera.

12. The camera tracking method of claim 10, further comprising measuring an internal variable of the main camera and an internal variable of the sub-camera.

13. The camera tracking method of claim 10, wherein the sub-image is a static image in which background is not occluded by a foreground object.

14. The camera tracking method of claim 10, further comprising:
predicting 3D coordinates of a feature point track of the main image by using the feature point track of the main image; and
connecting a plurality of cut tracks among the feature point track of the main image by using 3D feature point coordinates of the main image and the converted motion of the main camera.

15. The camera tracking method of claim 14, wherein the predicting of 3D coordinates comprises:
connecting two frames, among a plurality of frames from which the feature point track of the main image is started, as one pair;
selecting an effective frame pair among the frame pairs; and
obtaining 3D coordinates according to a mid-point algorithm by processing the selected frame pair.

16. The camera tracking method of claim 15, wherein when the frame pair is in plurality, the camera tracking method repeatedly performs the connecting of two frames, the selecting of an effective frame pair and the obtaining of 3D coordinates to use an average value of 3D coordinates, which is obtained as the repeatedly-performed result, as the 3D coordinates of the feature point track of the main image.

17. The camera tracking method of claim 14, wherein the connecting of a plurality of cut tracks connects any one track and another track among the cut tracks by using similarity between a feature point of the one track and a feature point of the other track.

18. A live video compositing system, comprising:
a main camera photographing a main image to be used in compositeness;
a sub-camera attached to the main camera to photograph a sub-image;
a tracking unit tracing a feature point track of the sub-image to estimate a motion of the sub-camera;
a motion conversion unit converting the motion of the sub-camera into a motion of the main camera on the basis of a position relationship between the main camera and the sub-camera;
a reconstruction unit tracing the feature point track of the main image to restore the traced feature point track of the main image to a Three-Dimensional (3D) space, and connecting a plurality of cut feature point tracks by using the converted motion of the main camera and a feature point track which is restored to the 3D space;
an optimization unit adjusting the restored 3D coordinates of the feature point track of the main image, 3D coordinates of the feature point track of the sub-image, a motion variable of the main camera and a motion variable of the sub-camera to optimize the converted motion of the main camera;
a CG object unit generating a CG object to be used in compositeness; and
a compositing unit compositing the main image and the CG object by using the optimized motion of the main camera.

19. The live video compositing system of claim 18, wherein the sub-image is a static image in which background is not occluded by a foreground object.

20. The live video compositing system of claim 18, wherein the reconstruction unit connects the cut tracks by using similarity between a feature point of any one track and a feature point of another track among the cut tracks.
